(19) United States
(12) Patent Application Publication
(10) Pub. No.: US 2025/0003842 A1
(43) Pub. Date: Jan. 2, 2025

(54) MICRO-SAMPLING MIXER AND MICRO-REACTION SYSTEM

(71) Applicant: TCL TECHNOLOGY GROUP CORPORATION, Huizhou, Guangdong (CN)

(72) Inventors: Yuan WANG, Huizhou, Guangdong (CN); Xiaolin YAN, Huizhou, Guangdong (CN)

(73) Assignee: TCL TECHNOLOGY GROUP CORPORATION, Huizhou, Guangdong (CN)

(21) Appl. No.: 18/711,126

(22) PCT Filed: Nov. 10, 2022
(86) PCT No.: PCT/CN2022/131014

§ 371 Date: May 17, 2024

(30) Foreign Application Priority Data
Nov. 17, 2021 (CN) 202111364280.0

(51) Int. Cl. G01N 1/38; B01L 3/00

(52) U.S. Cl. CPC G01N 1/38; B01L 3/00

(57) ABSTRACT

A micro-sampling mixer and a micro-reaction system are disclosed. The micro-sampling mixer includes a sample injection channel, a diluent injection channel, a mixing channel, and a connecting portion. One end of the sample injection channel is in communication with the mixing channel, and another end thereof is a sample input end. One end of the diluent injection channel is in communication with the mixing channel, and another end thereof is a diluent input end. The connecting portion is arranged on the mixing channel, and the connecting portion is connected to an external light detection device so as to perform light detection on a sample in the mixing channel.

This application claims priority to Chinese Patent Applications No. 202111364280.0, filed on Nov. 17, 2021 and entitled “MICRO-SAMPLING MIXER AND MICRO-REACTION SYSTEM”. The entire disclosures of the above application are incorporated herein by reference.

### TECHNICAL FIELD

The present application relates to the technical field of microfluidic reaction devices, and in particular, to a micro-sampling mixer and a micro-reaction system.

### BACKGROUND TECHNOLOGY

Microfluidic reactions are also called micro-channel reactions, fluid micro-reactions, or microfluidic reactions. Microfluidic reactions replace traditional batch reactions with continuous flow. Through continuous fluid mixing in microchannels or heating and other reaction conditions, a target product is continuously synthesized and reaction may be precisely controlled on a microscopic scale. This improves reaction selectivity and operational safety.

When using microfluidic reactions to prepare materials such as nanocrystals or quantum dots, not only may reaction be precisely controlled, but products in a flow may also be randomly detected based on online detection methods, and reaction conditions may also be adjusted based on detection results. However, currently, accuracy of real-time online detection of microfluidic reactions is not high due to a spectral interference between products and impact on a transmittance of excitation light.

### SUMMARY OF INVENTION

### Technical Problem

Accuracy of real-time online detection of microfluidic reactions is not high.

### Problem Solutions

### Technical Solutions

Therefore, the present application provides a micro-sampling mixer and a micro-reaction system.

Embodiments of the present application provide a micro-sampling mixer. The micro-sampling mixer includes a sample injection channel, a diluent injection channel, a mixing channel, and a connecting portion; wherein one end of the sample injection channel is in communication with the mixing channel, and another end of the sample injection channel is a sample input end; wherein one end of the diluent injection channel is in communication with the mixing channel, and another end of the diluent injection channel is a diluent input end; and wherein the connecting portion is arranged on the mixing channel, and the connecting portion is connected to an external optical inspection device.

Optionally, in some embodiments of the present application, the micro-sampling mixer is a micro-sampling chip.

Optionally, in some embodiments of the present application, a buffer chamber is provided at one end of the mixing channel, wherein the buffer chamber is in communication with the sample injection channel and the diluent injection channel.

Optionally, in some embodiments of the present application, a shape of the buffer chamber is spherical, hemispherical, heart-shaped, or gourd-shaped.

Optionally, in some embodiments of the present application, one end of the mixing channel away from the buffer chamber is a serpentine channel, and the serpentine channel is in communication with the buffer chamber.

Optionally, in some embodiments of the present application, an inner diameter of the serpentine channel is greater than an inner diameter of the sample injection channel.

Optionally, in some embodiments of the present application, the inner diameter of the serpentine channel is 3 to 5 times the inner diameter of the sample injection channel.

Optionally, in some embodiments of the present application, the mixing channel is formed by connecting a plurality of heart-shaped mixing chambers, each of the heart-shaped mixing chambers at one end of the mixing channel close to the sample injection channel serves as the buffer chamber, and the buffer chamber is in communication with the sample injection channel and the diluent injection channel.

Optionally, in some embodiments of the present application, an inner diameter of the diluent injection channel is greater than an inner diameter of the sample injection channel.

Optionally, in some embodiments of the present application, the inner diameter of the diluent injection channel is 3 to 5 times the inner diameter of the sample injection channel.

Optionally, in some embodiments of the present application, an inner diameter of the sample injection channel is 500-750 μm.

Optionally, in some embodiments of the present application, the connecting portion comprises a first sub-connecting portion and a second sub-connecting portion arranged oppositely, the first sub-connecting portion is connected to an incident excitation light fiber, and the second sub-connecting portion is connected to a luminescent optical fiber configured to receive light emitted by a product.

Optionally, in some embodiments of the present application, the sample injection channel comprises a first sub-channel, a second sub-channel, a third sub-channel, and a three-way connecting portion; wherein one end of the first sub-channel is a sample input end, and another end of the first sub-channel is connected to a first interface of the three-way connecting portion; one end of the second sub-channel is connected to a second interface of the three-way connecting portion, and another end of the second sub-channel is connected to the mixing channel; one end of the third sub-channel is connected to a third interface of the three-way connecting portion, and another end of the third sub-channel is connected to an external product collection device; wherein the first interface of the three-way connecting portion is in communication with the second interface, or the first interface is in communication with the third interface.

Optionally, in some embodiments of the present application, an inner diameter of the second sub-channel is ½˜⅓ of an inner diameter of the first sub-channel; an inner diameter of the mixing channel is 3-5 times an inner diameter of the first sub-channel.

Optionally, in some embodiments of the present application, an inner diameter range of the first sub-channel is 500-750 μm; an inner diameter range of the third sub-channel is 500-750 μm.

Optionally, in some embodiments of the present application, a material of the mixing channel is transparent silicon-based material or borosilicate glass.

Correspondingly, embodiments of the present application further provide a micro-reaction system, comprising a micro-reactor, a micro-sampling mixer, a light detection device, and a product collection device; wherein the micro-sampling mixer comprises a sample injection channel, a diluent injection channel, a mixing channel, and a connecting portion; wherein one end of the sample injection channel is in communication with the mixing channel, and another end of the sample injection channel is connected to the micro-reactor; one end of the diluent injection channel is in communication with the mixing channel, and another end of the diluent injection channel is connected to a product collection device; wherein the connecting portion is arranged on the mixing channel, and the connecting portion is connected to the light detection device.

Optionally, in some embodiments of the present application, the light detection device is selected from one or more of an infrared spectrum detection device, an ultraviolet spectrum detection device, a nuclear magnetic resonance detection device, a mass spectrometry detection device, a Raman spectrum detection device, a fluorescence spectrum detection device, or an optical rotation spectrum detection device.

Optionally, in some embodiments of the present application, the micro-reactor and the micro-sampling mixer are integrated into a micro-reaction sampling chip.

Optionally, in some embodiments of the present application, the micro-reactor is a micro-reaction chip, the micro-sampling mixer is a micro-sampling chip, and the micro-reaction chip is connected to the micro-sampling chip.

Optionally, in some embodiments of the present application, an inner diameter of the sample injection channel is same as an inner diameter of a pipe of the micro-reactor connected to the sample injection channel.

### Beneficial Effects of Invention

### Beneficial Effects

The micro-sampling mixer of the present application includes a sample injection channel, a diluent injection channel, a mixing channel, and a connecting portion. One end of the sample injection channel is in communication with the mixing channel, and another end thereof is a sample input end. One end of the diluent injection channel is in communication with the mixing channel, and another end thereof is a diluent input end. The connecting portion is arranged on the mixing channel, and the connecting portion is connected with an external light detection device to perform light detection on a sample in the mixing channel. The sample input end of the sample injection channel is in communication with an external micro-reactor, such that prepared and synthesized products may enter the micro-sampling mixer for subsequent detection. The sample injection channel and the diluent channel are both connected to the mixing channel, and product fluid and diluent are evenly mixed in the mixing channel to dilute the product to an appropriate concentration. The connecting portion on the mixing channel may be connected to an external light detection device. When the product diluted to a suitable concentration flows through the mixing channel, the light detection device performs spectral detection on the product in the channel through the connecting portion, thereby improving accuracy of spectral detection.

### BRIEF DESCRIPTION OF THE DRAWINGS

### Description of Drawings

In order to explain technical solutions in embodiments of the present application more clearly, drawings needed to be used in the description of the embodiments will be briefly introduced below. Obviously, the drawings in the following description are only some embodiments of the present application. For those skilled in the art, other drawings may also be obtained based on these drawings without exerting creative efforts.

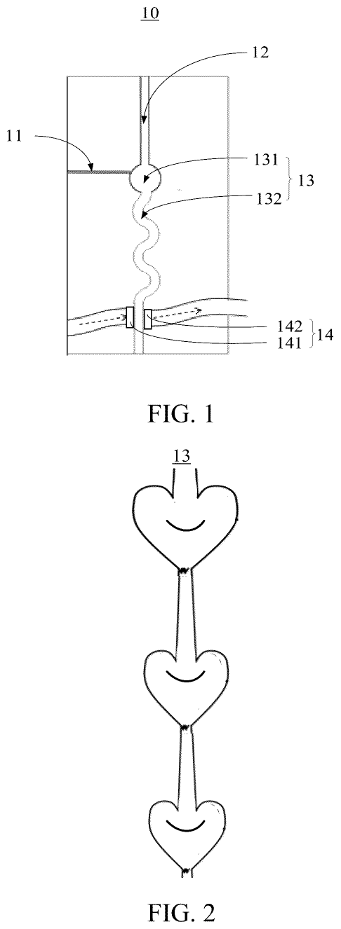

FIG. 1 is a schematic structural diagram of a micro-sampling mixer according to an embodiment of the present application.

FIG. 2 is a schematic structural diagram of a mixing channel according to an embodiment of the present application.

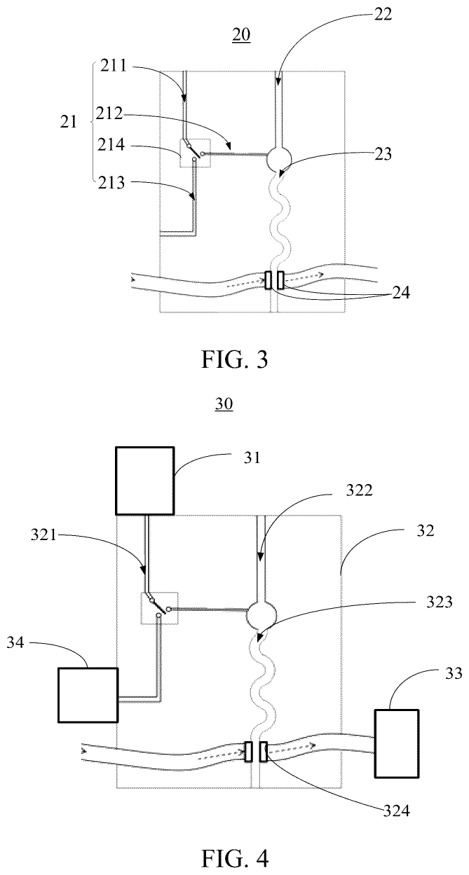

FIG. 3 is a schematic structural diagram of another micro-sampling mixer according to an embodiment of the present application.

FIG. 4 is a schematic structural diagram of a micro-reaction system according to an embodiment of the present application.

### DETAILED DESCRIPTION OF THE PREFERRED EMBODIMENTS

The technical solutions in the embodiments of the present application will be clearly and completely described below with reference to the accompanying drawings in the embodiments of the present application. Obviously, the described embodiments are only some of the embodiments of the present application, but not all of the embodiments. Based on the embodiments in this application, all other embodiments obtained by those skilled in the art without creative efforts fall within the scope of protection of this application.

In addition, it should be understood that the specific embodiments described here are only used to illustrate and explain the application, and are not used to limit the application. In this application, unless otherwise specified, the directional words used such as “upper” and “lower” specifically refer to the direction of the drawing in the drawings. In addition, in the description of this application, the term “including” means “including but not limited to.” Various embodiments of the invention may be presented as a range. It should be understood that the description in range form is merely for convenience and brevity and should not be construed as a rigid limitation on the scope of the present invention. Accordingly, the stated range descriptions should be considered to have specifically disclosed all possible subranges as well as the single values within such ranges. For example, a description of a range from 1 to 6 should be considered to have specifically disclosed subranges, such as from 1 to 3, from 1 to 4, from 1 to 5, from 2 to 4, from 2 to 6, from 3 to 6, etc., and A single number within the stated range, such as 1, 2, 3, 4, 5, and 6, applies regardless of the range. Additionally, whenever a numerical range is indicated herein, it is intended to include any cited number (fractional or whole) within the indicated range.

In this application, “at least one” means one or more. “Plural” means two or more. “At least one”, “at least one of the following” or similar expressions thereof refers to any combination of these items, including any combination of single item or plural items. For example, “at least one of a, b, or c”, or “at least one of a, b, and c” may mean: a, b, c, a-b (That is, a and b), a-c, b-c, or a-b-c, where a, b, and c may be single or multiple respectively.

The micro-sampling mixer provided in this application may be used for sampling and testing products in micro-flow reactions. For example, the product may be quantum dots or nanocrystalline materials, or other products with similar spectral properties to quantum dots or nanocrystalline materials. Specifically, the products or generated items prepared through microfluidic reaction synthesis may have characteristic spectra. Therefore, it may be detected by light detection devices such as infrared spectrum detection device, ultraviolet spectrum detection device, nuclear magnetic resonance detection device, mass spectrometry detection device, Raman spectrum detection device, fluorescence spectrum detection device, or optical rotation spectrum detection device. This enables analysis and identification of the molecular structure of the product. It may be understood that the product may be photo detected through one light detection device, or the structure of the product may be identified through a combination of two or more light detection devices.

Refer to FIG. 1, which is a schematic structural diagram of a micro-sampling mixer according to an embodiment of the present application. A micro-sampling mixer 10 includes a sample injection channel 11, a diluent injection channel 12, a mixing channel 13, and a connecting portion 14.

One end of the sample injection channel 11 is connected to the mixing channel 13, and another end thereof is a sample input end. The sample injection channel 11 may be connected to external equipment, such as a micro-reactor, through the sample input end. One end of the diluent injection channel 12 is connected to the mixing channel 13, and another end thereof is a diluent input end. The connecting portion 14 is provided on the mixing channel 13, and the connecting portion 14 is connected to an external light detection device to perform light detection on a sample in the mixing channel 13.

In this embodiment, the micro-sampling mixer 10 may introduce the external fluid containing the product into the mixing channel 13 through the sample injection channel 11, and at the same time introduce the external diluent into the mixing channel 13 through the diluent injection channel 12. The product and diluent are fully and evenly mixed in the mixing channel 13 to dilute the product to an appropriate concentration. The connecting portion 14 provided on the mixing channel 13 may be connected to an external light detection device. When the product diluted and mixed to a suitable concentration flows through the mixing channel 13, the light detection device performs spectral detection on the product in the channel through the connecting portion 14. This improves the accuracy of spectral detection and enables real-time monitoring and accurate determination of microfluidic reaction products. Based on the real-time and accurate detection results, the microfluidic reaction system may be controlled in real time and accurately. It may be understood that the fluid in the mixing channel 13 may not flow through the connecting portion 14, nor may it flow through the connecting portion 14 and enter the external light detection device, that is, the mixing channel 13 is connected to the connecting portion 14 but does not in communication with it.

In a specific embodiment, the micro-sampling mixer 10 is a micro-sampling chip. In this embodiment, the sample injection channel 11, the diluent injection channel 12, the mixing channel 13, and the connection portion 14 are all provided on the micro-sampling chip. As a whole, the integration of the micro-sampling mixer 10 is improved. The micro-sampling chip may be flexibly and conveniently connected to various micro-reactors or light detection devices to achieve convenient real-time spectral detection of products synthesized by micro-reactions. The specific material of the micro-sampling chip may be a silicon-based material or borosilicate glass with high transparency, in which case the mixing channel 13 may transmit light. Therefore, the light detection device connected to the connecting portion 14 may perform spectral detection on the products flowing therein through the mixing channel 13.

In a specific embodiment, a buffer chamber 131 is provided at one end of the mixing channel 13, and the buffer chamber 131 is connected to the sample injection channel 11 and the diluent injection channel 12. The arrangement of the buffer chamber 131 provides a buffer space to relieve pressure in the sample injection channel 11 and the diluent injection channel 12. This may avoid increasing the pressure of each pipe in the micro-sampling mixer and avoid backflow of the flow system when the fluid flow in the sample injection channel 11 or the diluent injection channel 12 is large. That is, the fluid flows in the direction of the sample input end in the sample injection channel 11, or the fluid flows in the direction of the diluent input end in the diluent injection channel 12.

The shape of the buffer chamber 131 may be spherical, hemispherical, heart-shaped, gourd-shaped, etc., and its shape is not limited here.

In this embodiment, a separate buffer chamber 131 is provided in the mixing channel 13 to provide pressure buffering for the system environment. In other embodiments, the buffer space may also be provided by configuring the shape of the mixing unit in the mixing channel 13. For example, the mixing channel 13 is formed by connecting multiple heart-shaped mixing chambers. Refer to FIG. 2, which is a schematic structural diagram of a mixing channel according to an embodiment of the present application. At least one heart-shaped mixing chamber at one end of the mixing channel 13 close to the sample injection channel 11 and the diluent injection channel 12 may also be used as a buffer chamber 131.

In one embodiment, one end of the mixing channel 13 is a buffer chamber 131 and also includes a serpentine channel 132 connected with the buffer chamber 131. The serpentine channel 132 may increase the mixing of the sample solution and the diluent, so that the sample may be mixed and diluted more uniformly. An inner diameter of the serpentine channel 132 may be set larger than the sample injection channel 11. Specifically, the inner diameter of the serpentine channel 132 may be 3 to 5 times an inner diameter of the sample injection channel 11, thereby avoiding an increase in the pressure of each pipe of the micro-sampling mixer 10 under large flow rates.

In one embodiment, the inner diameter of the diluent injection channel 12 may be set larger than the sample injection channel 11, for example, it may be 3 to 5 times the inner diameter of the sample injection channel 11. This enables rapid dilution of the product solution with a large flow of diluent.

In one embodiment, the inner diameter of the sample injection channel 11 may be the same as the inner diameter of the sample pipe of the micro-reactor connected to the sample input end. Specifically, the inner diameter of the sample injection channel 11 may range from 500 μm to 750 μm, such as 500 μm, 550 μm, 600 μm, 650 μm, 700 μm, and 750 μm.

In a specific embodiment, the connecting portion 14 is provided on the mixing channel 13, and may specifically be a first sub-connecting portion 141 and a second sub-connecting portion 142 that are oppositely arranged. Both the first sub-connecting portion 141 and the second sub-connecting portion 142 are connected to optical fibers. Specifically, the first sub-connecting portion 141 may be connected to the incident excitation light optical fiber, and the second sub-connecting portion 142 is connected to the luminescent optical fiber that receives the light emitted by the product. Thereby, an excitation light is given to the product flowing in the mixing channel 13 through the first sub-connecting portion 141. The optical signal generated after the product is excited is received through the optical fiber connected to the second sub-connecting portion 142 and transmitted to the light detection device for analysis of the optical signal.

Further, refer to FIG. 3, which is a schematic structural diagram of another micro-sampling mixer according to an embodiment of the present application. A micro-sampling mixer 20 includes a sample injection channel 21, a diluent injection channel 22, a mixing channel 23, and a connecting portion 24. For the diluent injection channel 22, the mixing channel 23, and the connecting portion 24, reference may be made to the relevant descriptions of the diluent injection channel 12, the mixing channel 13, and the connecting portion 14 in the previous embodiment, which will not be described again here.

Specifically, the sample injection channel 21 includes a first sub-channel 211, a second sub-channel 212, a third sub-channel 213, and a three-way connecting portion 214.

One end of the first sub-channel 211 is a sample input end, and another end thereof is connected to a first interface of a three-way connecting portion 214. One end of the second sub-channel 212 is connected to a second interface of the three-way connecting portion 214, and another end thereof is connected to the mixing channel 23. One end of the third sub-channel 213 is connected to a third interface of the three-way connecting portion 214, and another end thereof is connected to an external product collection device. The first interface of the three-way connecting portion 214 is in communication with the second interface, or the first interface is in communication with the third interface. That is, the first interface may be selectively in communication with the second interface or the third interface through the three-way connecting portion 214, such that the first sub-channel 211 may be selectively in communication with the second sub-channel 212 or the third sub-channel 213. Then, during the reaction process, the product solution may be obtained in real time according to the demand, diluted and mixed for light detection. When the first sub-channel 211 is in communication with the second sub-channel 212, the reaction solution or product solution flowing through the first sub-channel 211 flows into the second sub-channel 212, and then flows into an external product collection device connected to the second sub-channel 212 to collect the synthetically prepared products. When sampling and detection are required, the first sub-channel 211 and the third sub-channel 213 are in communication with each other. The reaction solution or product solution flowing through the first sub-channel 211 flows into the third sub-channel 213 and flows into the mixing channel 23 for dilution and mixing. The diluted product solution flowing through the mixing channel 23 is optically detected through the light detection device connected to the connecting portion 24 to determine the structure in the synthesized product solution for analysis and identification.

In this embodiment, the inner diameter of the first sub-channel 211 may be the same as or close to the channel size of the micro-reactor to which it is connected. This prevents the flow rate of the fluid from the micro-reactor into the first sub-channel 211 from being too slow, making it impossible to quickly obtain a sufficient amount of product for subsequent light detection. Specifically, the inner diameter of the first sub-channel 211 may range from 500 to 750 μm, such as 500 μm, 550 μm, 600 μm, 650 μm, 700 μm, or 750 μm.

In this embodiment, the inner diameter of the second sub-channel 212 may be smaller than the inner diameter of the first sub-channel 211. This may increase the flow rate of the fluid in the second sub-channel 212 under the same flow rate, so that the fluid reaches the mixing channel 23 quickly. Specifically, the inner diameter of the second sub-channel 212 may be ½ to ⅓ of the inner diameter of the first sub-channel 211.

In this embodiment, the inner diameter of the third sub-channel 213 may be the same as or close to the inner diameter of the first sub-channel 211. This avoids changes in flow rate or pressure due to changes in the inner diameter of the channel when the two are connected, so that product collection may be achieved continuously and stably. Specifically, the inner diameter of the third sub-channel 213 may range from 500 to 750 μm, such as 500 μm, 550 μm, 600 μm, 650 μm, 700 μm, or 750 μm.

In this embodiment, the inner diameter of the mixing channel 23 may be 3-5 times the inner diameter of the first sub-channel 211. It may be understood that the mixing channel 23 may be a channel with the same inner diameter and cross-sectional shape, or it may be changed. The mixing channel 23 may be a common micro-mixing structure in the art.

In this embodiment, the micro-sampling mixer 20 may be a micro-sampling chip. In this embodiment, the sample injection channel 21, the diluent injection channel 22, the mixing channel 23 and the connection part 24 are all provided on the micro-sampling chip as a whole. This increases the integration of the micro-sampling mixer 20. This micro-sampling chip may be flexibly and conveniently connected to various micro-reactors or light detection devices to achieve convenient real-time spectral detection of products synthesized by micro-reactions.

Furthermore, the material of the mixing channel 23 is a transparent silicon-based material or borosilicate glass, that is, the mixing channel 23 may transmit light and support the transmission of light. The light detection device connected to the connecting portion 14 may perform spectral detection on the product flowing therein through the mixing channel 23. Other parts of the micro-sampling mixer 20 may also be made of silicon-based materials or borosilicate glass with higher transparency. That is, the material of the micro-sampling mixer 20 may be a silicon-based material or borosilicate glass with higher transparency.

This application further provides a micro-reaction system. Refer to FIG. 4, which is a schematic structural diagram of a micro-reaction system provided by an embodiment of the present application. A micro-reaction system 30 includes a micro-reactor 31, a micro-sampling mixer 32, a light detection device 33, and a product collection device 34.

The micro-sampling mixer 32 includes a sample injection channel 321, a diluent injection channel 322, a mixing channel 323, and a connecting portion 324. One end of the sample injection channel 321 is in communication with the mixing channel 323, and another end thereof is connected the micro-reactor 31. One end of the diluent injection channel 322 is in communication with the mixing channel 323, and another end thereof is connected to the product collection device 34. The connecting portion 324 is provided on the mixing channel 323, and the connecting portion 323 is connected to the light detection device 33 to perform light detection on a sample in the mixing channel 323.

In this example, through the micro-reactor 31, the micro-sampling mixer 32, the light detection device 33, and the product collection device 34 in the micro-reaction system 30, it may be used for microchannel synthesis, sampling and testing of products, and product collection. The product testing may be carried out in real time according to demand, which improves the continuity of product preparation and improves production efficiency. When the micro-reaction system 30 continuously synthesizes products, the micro-sampling mixer 32 performs rapid sampling, rapid and uniform dilution and mixing, so that the light detection device 33 connected thereto may perform accurate product detection. In addition, the channel arrangement such as dilution and mixing of the micro-sampling mixer 32 may not cause excessive pressure on each channel of the micro-sampling mixer 32 itself. This may not cause excessive pressure issues in the channels in the micro-reactor 31 connected thereto, and may not affect the fluid velocity and channel pressure of the entire micro-reactor system 30.

For detailed descriptions of the sample injection channel 321, the diluent injection channel 322, the mixing channel 323, and the connecting portion 324, reference may be made to the relevant descriptions of the micro-sampling mixer 10 and the micro-sampling mixer 20 above, and will not be described again here.

The micro-reactor 31 is mainly used for synthesizing products or products, and may be a micro-reactor known in the art. The light detection device 33 is mainly used for light detection of products for product structure identification. The light detection device is selected from at least one of an infrared spectrum detection device, an ultraviolet spectrum detection device, a nuclear magnetic resonance detection device, a mass spectrometry detection device, a Raman spectrum detection device, a fluorescence spectrum detection device, or an optical rotation spectrum detection device. That is, the product is optically detected through one or two or more light detection devices to detect the structure, purity or content of the product.

Further, the micro-reactor 31 and the micro-sampling mixer 32 may be integrated into a micro-reaction sampling chip. That is, the micro-reactor 31 and the micro-sampling mixer 32 are formed on one chip, with high integration and small volume. The micro-reactor 31 and the micro-sampling mixer 32 may be corresponding chips respectively. That is, the micro-reactor 31 is a micro-reaction chip, and the micro-sampling mixer 32 is a micro-sampling chip, and the two are connected through a channel, such as a capillary tube. The micro-sampling mixer 32 may be flexibly connected to a variety of micro-reactors 31. While having a high degree of integration, it also has good flexibility and convenience.

The micro-sampling mixer and micro-reaction system provided in the embodiments of the present application have been introduced in detail above. This article uses specific examples to illustrate the principles and implementation methods of this application. The description of the above embodiments is only used to help understand the method and its core idea of the present application. In addition, for those skilled in the art, there will be changes in the specific implementation and application scope based on the ideas of this application. In summary, the contents of this specification should not be construed as limiting this application.

1. A micro-sampling mixer, comprising:
a sample injection channel, a diluent injection channel, a mixing channel, and a connecting portion;
wherein one end of the sample injection channel is in communication with the mixing channel, and another end of the sample injection channel is a sample input end;
wherein one end of the diluent injection channel is in communication with the mixing channel, and another end of the diluent injection channel is a diluent input end; and
wherein the connecting portion is arranged on the mixing channel, and the connecting portion is connected to an external optical inspection device.

2. The micro-sampling mixer according to claim 1, wherein the micro-sampling mixer is a micro-sampling chip.

3. The micro-sampling mixer according to claim 1, further comprising a buffer chamber provided at one end of the mixing channel, wherein the buffer chamber is in communication with the sample injection channel and the diluent injection channel.

4. The micro-sampling mixer according to claim 3, wherein a shape of the buffer chamber is spherical, hemispherical, heart-shaped, or gourd-shaped.

5. The micro-sampling mixer according to claim 3, wherein one end of the mixing channel away from the buffer chamber is a serpentine channel, and the serpentine channel is in communication with the buffer chamber.

6. The micro-sampling mixer according to claim 3, wherein an inner diameter of the serpentine channel is greater than an inner diameter of the sample injection channel.

7. The micro-sampling mixer according to claim 6, wherein the inner diameter of the serpentine channel is 3 to 5 times the inner diameter of the sample injection channel.

8. The micro-sampling mixer according to claim 1 or 2, wherein the mixing channel is formed by connecting a plurality of heart-shaped mixing chambers, each of the heart-shaped mixing chambers at one end of the mixing channel close to the sample injection channel serves as the buffer chamber, and the buffer chamber is in communication with the sample injection channel and the diluent injection channel.

9. The micro-sampling mixer according to claim 1 or 2, wherein an inner diameter of the diluent injection channel is greater than an inner diameter of the sample injection channel.

10. The micro-sampling mixer according to claim 9, wherein the inner diameter of the diluent injection channel is 3 to 5 times the inner diameter of the sample injection channel.

11. The micro-sampling mixer according to claim 1, wherein an inner diameter of the sample injection channel is 500-750 μm.

12. The micro-sampling mixer according to claim 1, wherein the connecting portion comprises a first sub-connecting portion and a second sub-connecting portion arranged oppositely, the first sub-connecting portion is connected to an incident excitation light fiber, and the second sub-connecting portion is connected to a luminescent optical fiber configured to receive light emitted by a product.

13. The micro-sampling mixer according to claim 1, wherein the sample injection channel comprises a first sub-channel, a second sub-channel, a third sub-channel, and a three-way connecting portion;
wherein one end of the first sub-channel is a sample input end, and another end of the first sub-channel is connected to a first interface of the three-way connecting portion; one end of the second sub-channel is connected to a second interface of the three-way connecting portion, and another end of the second sub-channel is connected to the mixing channel; one end of the third sub-channel is connected to a third interface of the three-way connecting portion, and another end of the third sub-channel is connected to an external product collection device;
wherein the first interface of the three-way connecting portion is in communication with the second interface, or the first interface is in communication with the third interface.

14. The micro-sampling mixer according to claim 13, wherein an inner diameter of the second sub-channel is ½˜⅓ of an inner diameter of the first sub-channel; an inner diameter of the mixing channel is 3-5 times an inner diameter of the first sub-channel.

15. The micro-sampling mixer according to claim 13, wherein an inner diameter range of the first sub-channel is 500-750 μm; an inner diameter range of the third sub-channel is 500-750 μm.

16. The micro-sampling mixer according to claim 1, wherein a material of the mixing channel is transparent silicon-based material or borosilicate glass.

17. A micro-reaction system, comprising:
a micro-reactor, a micro-sampling mixer, a light detection device, and a product collection device;
wherein the micro-sampling mixer comprises a sample injection channel, a diluent injection channel, a mixing channel, and a connecting portion;
wherein one end of the sample injection channel is in communication with the mixing channel, and another end of the sample injection channel is connected to the micro-reactor; one end of the diluent injection channel is in communication with the mixing channel, and another end of the diluent injection channel is connected to a product collection device;
wherein the connecting portion is arranged on the mixing channel, and the connecting portion is connected to the light detection device.

18. The micro-reaction system according to claim 17, wherein the light detection device is selected from one or more of an infrared spectrum detection device, an ultraviolet spectrum detection device, a nuclear magnetic resonance detection device, a mass spectrometry detection device, a Raman spectrum detection device, a fluorescence spectrum detection device, or an optical rotation spectrum detection device.

19. The micro-reaction system according to claim 17, wherein the micro-reactor and the micro-sampling mixer are integrated into a micro-reaction sampling chip.

20. The micro-reaction system according to claim 17, wherein the micro-reactor is a micro-reaction chip, the micro-sampling mixer is a micro-sampling chip, and the micro-reaction chip is connected to the micro-sampling chip.
